(19) United States
(12) Patent Application Publication
(10) Pub. No.: US 2016/0050031 A1
(43) Pub. Date: Feb. 18, 2016

(54) AUTOMATED BLIND COEFFICIENT CONTROL IN ANALOG ACTIVE INTERFERENCE CANCELLATION

(71) Applicant: QUALCOMM Incorporated, San Diego, CA (US)

(72) Inventors: Insoo Hwang, San Diego, CA (US); Bongyong Song, San Diego, CA (US); Samir Salib Soliman, Poway, CA (US); Cong Nguyen, San Diego, CA (US)

(21) Appl. No.: 14/459,595

(22) Filed: Aug. 14, 2014

(51) Int. Cl. H04B 15/00; H04L 25/06; H04B 1/40; H04L 25/08

(52) U.S. Cl. CPC H04B 15/00; H04L 25/08; H04L 25/06; H04B 1/40

(57) ABSTRACT

Aspects of the disclosure are directed to interference cancellation and wireless communication. An analog active interference cancellation circuit may be configured to cancel in-device interference corresponding to transmissions from a transmitter at a wireless communication device, which affects the performance of a receiver at the wireless communication device. The interference cancellation circuit may be configured according to one or more digital coefficients calculated based on a baseband downconverted from the RF output of the receiver. That is, the digital coefficient may be converted to an analog coefficient and applied to the interference cancellation circuit.

### TECHNICAL FIELD

This disclosure relates generally to the field of interference cancellation systems and methods, and, in particular, to a cancellation of interference produced by multiple radios operating on the same, adjacent, harmonic/sub-harmonic, or intermodulation product frequencies using digitally generated coefficients.

### BACKGROUND

Advanced wireless devices may have multiple radios (e.g., WWAN, WLAN, WPAN, GPS/GLONASS, etc.) that operate on the same, adjacent, or harmonic/sub-harmonic frequencies. However, some combinations of radios can cause co-existence issues due to interference between the respective frequencies. In particular, when one radio is actively transmitting at or close to the same frequency and at a same time that another radio is receiving, the transmitting radio can cause interference to (i.e., de-sense) the receiving radio. For example, same-band interference may occur between Bluetooth (WPAN) and 2.4 GHz WiFi (WLAN); adjacent band interference between WLAN and LTE band 7, 40, 41; harmonic/sub-harmonic interference may occur between 5.7 GHz ISM and 1.9 GHz PCS; and an intermodulation issue may occur between 700 MHz band transmitters and a GPS receiver.

Active interference cancellation (AIC) cancels interference between a transmitter radio and a receiver radio by matching gain and phase of a wireless coupling path signal and in a wired AIC path, as shown in FIG. 1, where dₜ is a transmitted signal from a transmitter (aggressor) radio 102, and h_{c} is a coupling channel (wireless coupling path signal) from the transmitter radio 102 to a receiver (victim) radio 104. AIC 106 attempts to cancel the impact of the coupling channel h_{c} as reflected via the negative sign on the output of AIC 106.

AIC may be implemented with respect to RF (radio frequency), baseband, or both RF/baseband. AIC in baseband typically only shows limited cancellation performance because the coupling path signal is much stronger than the desired signal strength, easily resulting in the saturation of an LNA (low-noise amplifier) and an ADC (analog-to-digital converter). AIC in RF can provide better cancellation performance. Prior art RF AIC techniques include difference calibration methods, such as direct channel estimation and cancellation method, binary search the coupling phase, and LMS (least mean squares)-based adaptive filtering methods.

### SUMMARY

The following presents a simplified summary of one or more aspects of the present disclosure, in order to provide a basic understanding of such aspects. This summary is not an extensive overview of all contemplated features of the disclosure, and is intended neither to identify key or critical elements of all aspects of the disclosure nor to delineate the scope of any or all aspects of the disclosure. Its sole purpose is to present some concepts of one or more aspects of the disclosure in a simplified form as a prelude to the more detailed description that is presented later.

Aspects of the disclosure provide for a “blindly” controllable interference cancellation coefficient computation method and apparatus for RF and analog interference cancellation. The correct control of the coefficients enables the AIC circuit to cancel the interference at the desired point (frequency), e.g., receiver in-band, or the point that the in-band interference is the greatest.

In some examples, an interfering signal may be observed at baseband. Based on these observations, digital coefficients may be generated, and then converted to an analog signal to control the coefficients of the AIC. Thus, the AIC can steer the cancellation region to be centered at or near the desired center frequency based on these observations in the digital domain. Control of the coefficients may be accomplished either entirely at the baseband, or partially at the baseband in combination with an analog LMS filter.

Exemplary blind control algorithms may include stochastic optimization (e.g., a Kiefer-Wolfowitz procedure), quadratic curve fitting, and a genetic algorithm. Depending on the availability of a reference on the interference (e.g., a reference signal from the transmitter using a directional coupler), the AIC can utilize blind and non-blind coefficients and enable DC offset updates. The DC control of the DC offset can be accomplished in baseband. The computation can be done for both the DC offset and LMS coefficient, so the feedback loop to the RF AIC can also be avoided.

In one aspect, the disclosure provides a method of performing interference cancellation in a device having at least one transmitter and at least one receiver. Here, the method includes receiving an interfering signal from the transmitter at the receiver, determining a digital coefficient for interference cancellation of the interfering signal, based on a baseband signal, converting the digital coefficient to an analog coefficient, and applying the analog coefficient to an interference cancellation circuit to cancel the interfering signal.

Another aspect of the disclosure provides an apparatus configured for wireless communication, including at least one processor, a memory coupled to the at least one processor, at least one transmitter coupled to the at least one processor, at least one receiver coupled to the at least one processor, and an interference cancellation circuit coupled between the at least one transmitter and the at least one receiver. Here, the at least one processor is configured to receive an interfering signal from the transmitter at the receiver, to determine a digital coefficient for interference cancellation of the interfering signal, based on a baseband signal, to convert the digital coefficient to an analog coefficient, and to apply the analog coefficient to the interference cancellation circuit to cancel the interfering signal.

Another aspect of the disclosure provides an apparatus configured for wireless communication. Here, the apparatus includes at least one transmitter, at least one receiver, means for interference cancellation, coupled between the at least one transmitter and the at least one receiver, and configured to apply interference cancellation to an interfering signal from the transmitter received at the receiver, means for determining a digital coefficient for interference cancellation of the interfering signal, based on a baseband signal, means for converting the digital coefficient to an analog coefficient, and means for applying the analog coefficient to the means for interference cancellation to cancel the interfering signal.

Another aspect of the disclosure provides a computer-readable medium storing computer executable code, operable on a device that includes at least one transmitter, at least one receiver, and an interference cancellation circuit coupled between the at least one transmitter and the at least one receiver, and configured to apply interference cancellation to an interfering signal from the transmitter received at the receiver. The computer executable code includes instructions for causing a computer to determine a digital coefficient for interference cancellation of the interfering signal, based on a baseband signal, instructions for causing a computer to convert the digital coefficient to an analog coefficient, and instructions for causing a computer to apply the analog coefficient to the means for interference cancellation to cancel the interfering signal.

These and other aspects of the invention will become more fully understood upon a review of the detailed description, which follows. Other aspects, features, and embodiments of the present invention will become apparent to those of ordinary skill in the art, upon reviewing the following description of specific, exemplary embodiments of the present invention in conjunction with the accompanying figures. While features of the present invention may be discussed relative to certain embodiments and figures below, all embodiments of the present invention can include one or more of the advantageous features discussed herein. In other words, while one or more embodiments may be discussed as having certain advantageous features, one or more of such features may also be used in accordance with the various embodiments of the invention discussed herein. In similar fashion, while exemplary embodiments may be discussed below as device, system, or method embodiments it should be understood that such exemplary embodiments can be implemented in various devices, systems, and methods.

### BRIEF DESCRIPTION OF THE DRAWINGS

FIG. 1 is a simplified block diagram of an active interference cancellation system.

FIG. 2 is a block diagram illustrating an environment that includes a device according to various embodiments of the disclosure.

FIG. 3 is a block diagram of an illustrative hardware configuration for an apparatus employing a processing system according to various embodiments of the disclosure.

FIG. 4 is a block diagram of a wireless communication device having plural transmitters and plural receivers, according to various embodiments of the disclosure.

FIGS. 5-8 illustrate block diagrams of systems for performing interference cancellation according to various embodiments of the disclosure.

FIG. 9 depicts a plot for illustrating a curve fitting approach to determining a least mean squares (LMS) filter coefficient according to various embodiments of the disclosure.

FIG. 10 illustrates a flow chart of an exemplary method for performing interference cancellation according to various embodiments of the disclosure.

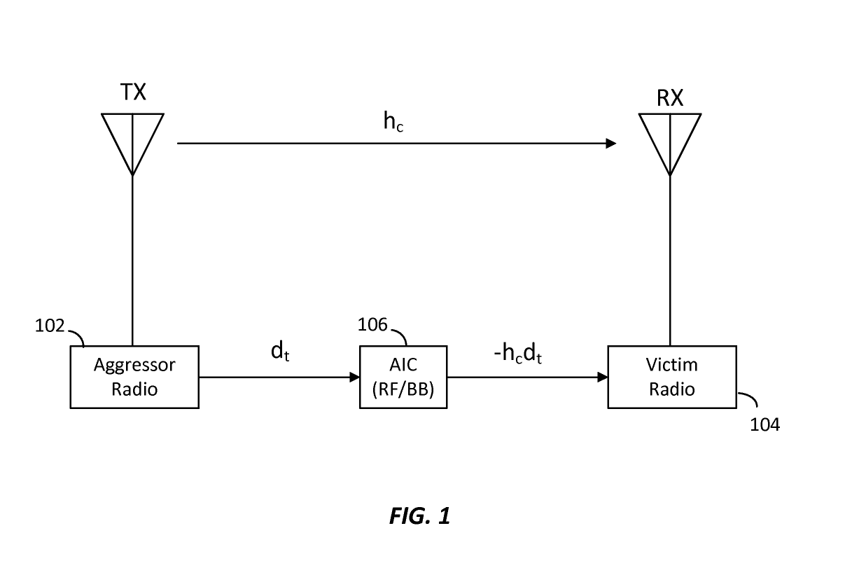

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Various aspects of the disclosure relate to systems and methods for cancelling in-device interference resulting from transmissions by one radio (transceiver) that affect the receiving performance of a second radio (transceiver) operating on the same or adjacent, harmonic/sub-harmonic frequencies, or intermodulation product frequencies. In particular aspects, an interference cancellation system is adaptable for different radio combinations. For instance, for a co-existence issue caused by a first combination of radios, a transmitting radio (e.g., WiFi) may be selected for an input of an interference cancellation (IC) circuit and a receiving radio (e.g., Bluetooth) may be selected for the output of the IC circuit. For a co-existence issue caused by a second (different) combination of radios, the transmitting radio (e.g., WiFi) may be selected for the input of the IC circuit and the receiving radio (e.g., LTE band 7) may be selected for the output of the IC circuit. It should be noted that the terms cancellation (as in interference cancellation) and variants thereof may be synonymous with reduction, mitigation, and/or the like in that at least some interference is reduced.

In various representative aspects, the IC circuit includes an analog one-tap least mean squares (LMS) adaptive filter configured to match the signal in the IC path with the signal in the coupling path. That is, while a one-tap LMS interference cancellation filter ideally focuses its peak cancellation energy at the frequency where the power of the interfering signal is at its highest, a conventional LMS filter may suffer from a mismatch between the cancellation center and the peak interference power. In accordance with various aspects of the present disclosure, a DC offset may be applied to the LMS filter to actively steer the cancellation region, with the value of the DC offset being automatically calculated in the digital domain in accordance with a baseband signal. In further aspects of the disclosure, LMS filter coefficients may additionally or alternatively be calculated in the digital domain in accordance with the baseband signal.

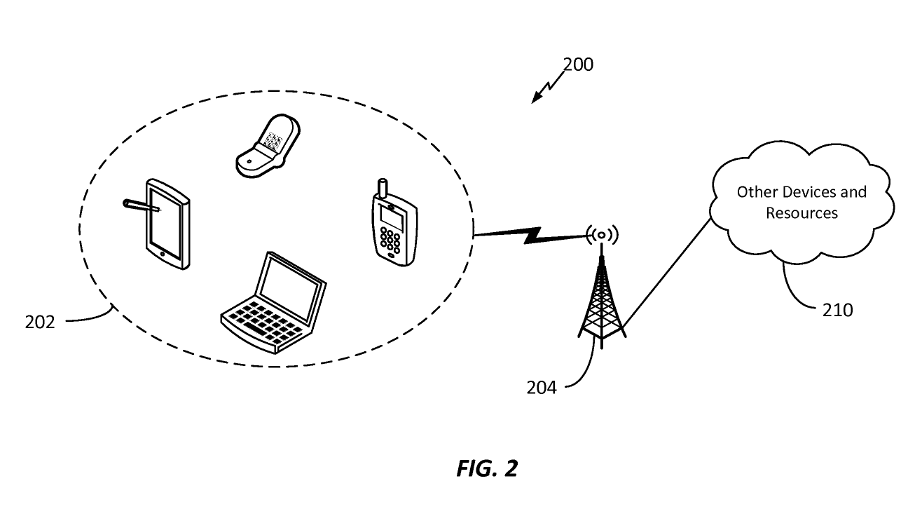

FIG. 2 is a block diagram illustrating an environment 200 that includes one or more devices 202. The environment 200 may be representative of any system(s) or a portion thereof that may include at least one wireless communication device 202 enabled to transmit and/or receive wireless signals to/from at least one wireless network 204. The device 202 may, for example, be a mobile device or a device that while movable is primarily intended to remain stationary. For example, the device may be a cellular phone, a smart phone, a personal digital assistant, a portable computing device, a navigation device, a tablet, etc. The device 202 may also be a stationary device (e.g., a desktop computer, machine-type communication device, etc.) enabled to transmit and/or receive wireless signals. In yet other aspects, the device 202 may take the form of one or more integrated circuits, circuit boards, and/or the like that may be operatively enabled for use in another device. Thus, as used herein, the terms “device” and “mobile device” may be used interchangeably as each term is intended to refer to any single device or any combinable group of devices that may transmit and/or receive wireless signals.

The wireless network 204 may, for example, be representative of any wireless communication system or network that may be enabled to receive and/or transmit wireless signals. By way of example but not limitation, the wireless network 204 may include one or more of a wireless wide area network (WWAN), a wireless local area network (WLAN), a wireless personal area network (WPAN), a wireless metropolitan area network (WMAN), a Bluetooth communication system, WiFi communication system, Global System for Mobile communication (GSM) system, Evolution Data Only/Evolution Data Optimized (EVDO) communication system, Ultra Mobile Broadband (UMB) communication system, Long Term Evolution (LTE) communication system, Mobile Satellite Service-Ancillary Terrestrial Component (MSS-ATC) communication system, and/or the like.

The wireless network 204 may be enabled to communicate with and/or otherwise operatively access other devices and/or resources as represented simply by cloud 210. For example, the cloud 210 may include one or more communication devices, systems, networks, or services, and/or one or more computing devices, systems, networks, or services, and/or the like or any combination thereof.

In various examples, the wireless network 204 may utilize any suitable multiple access and multiplexing scheme, including but not limited to Code Division Multiple Access (CDMA), Time Division Multiple Access (TDMA), Frequency Division Multiple Access (FDMA), Orthogonal Frequency Division Multiple Access (OFDMA), Single-Carrier Frequency Division Multiple Access (SC-FDMA), etc. In examples where the wireless network 204 is a WWAN, the network may implement one or more standardized radio access technologies (RATs) such as Digital Advanced Mobile Phone System (D-AMPS), IS-95, cdma2000, Global System for Mobile Communications (GSM), UMTS, eUTRA (LTE), or any other suitable RAT. GSM, UMTS, and eUTRA are described in documents from a consortium named “3rd Generation Partnership Project” (3GPP). IS-95 and cdma2000 are described in documents from a consortium named “3rd Generation Partnership Project 2” (3GPP2). 3GPP and 3GPP2 documents are publicly available. In examples where the wireless network 204 is a WLAN, the network may be an IEEE 802.11x network, or any other suitable network type. In examples where the wireless network 204 is a WPAN, the network may be a Bluetooth network, an IEEE 802.15x, or any other suitable network type.

The device 202 may include at least one radio (also referred to as a transceiver). The terms “radio” or “transceiver” as used herein refers to any circuitry and/or the like that may be enabled to receive wireless signals and/or transmit wireless signals. In particular aspects, two or more radios may be enabled to share a portion of circuitry and/or the like (e.g., a processing unit, memory, etc.). That is the terms “radio” or “transceiver” may be interpreted to include devices that have the capability to both transmit and receive signals, including devices having separate transmitters and receivers, devices having combined circuitry for transmitting and receiving signals, and/or the like.

In some aspects, the device 202 may include a first radio enabled to receive and/or transmit wireless signals associated with at least a first network of a wireless network 204 and a second radio that is enabled to receive and/or transmit wireless signals associated with at least a second network of the wireless network 204 and/or at least one navigation system 206 (e.g., a satellite positioning system and/or the like).

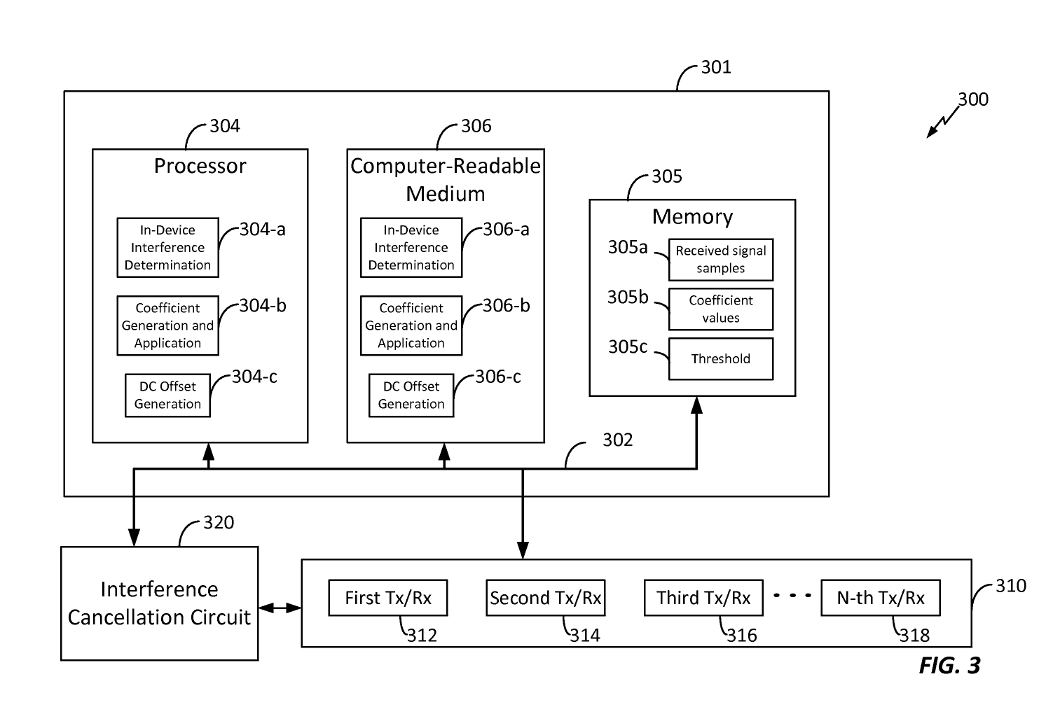

FIG. 3 is a block diagram of an illustrative hardware configuration for an apparatus 300 including a processing system 301, according to various aspects of the disclosure. For example, the apparatus 300 may be a wireless communication device as illustrated in any one or more of FIGS. 2, 4, 5, 6, 7, and/or 8. In this example, the processing system 301 may be implemented with a bus architecture represented generally by bus 302. The bus 302 may include any number of interconnecting buses and bridges depending on the specific application of the processing system 301 and the overall design constraints. The bus 302 links together various circuits including one or more processors, represented generally by the processor 304, memory 305, and computer-readable media, represented generally by the computer-readable medium 306. The bus 302 may also link various other circuits such as timing sources, peripherals, voltage regulators, and power management circuits, which are well known in the art, and therefore, will not be described any further. The bus 302 may further link to a plurality of transmitters and/or receivers 310 and an interference cancellation circuit 320. Each of the Tx/Rx circuits 310 allows for transmitting to and/or receiving from various other apparatus over a transmission medium. The interference cancellation circuit 320 is described in further detail below.

The memory 305 may be used to store data or information. For example, the memory 305 may store data indicative of one or more samples of a received signal 305a. At least a portion of the samples may be composed of interference due to, e.g., an aggressor transmitter.

The memory 305 may store data indicative of one or more coefficients or coefficient values 305b that may be used to perform interference cancellation with respect to the received signal. The coefficients 305b may be in a digital format and may be configured to support conversion to an analog format as described further below.

The memory 305 may store data indicative of a threshold 305c. The threshold 305c may be used as a basis for comparison in determining when interference has been reduced to an acceptable level.

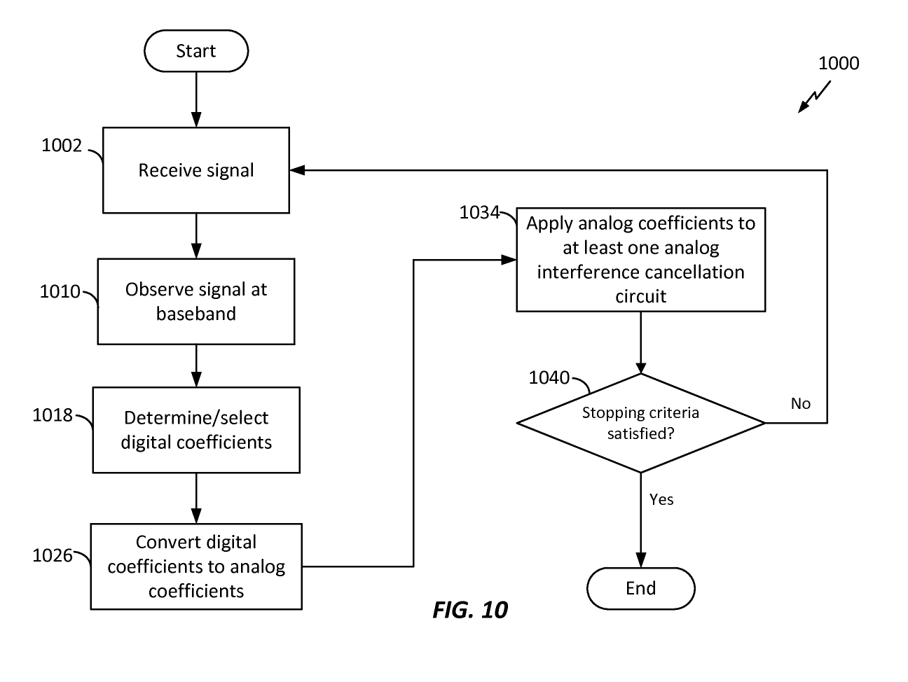

The processor 304 is responsible for managing the bus 302 and general processing, including the execution of software 307 stored on computer-readable storage medium 306 and/or memory 305. Examples of processors 304 include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. That is, the processor 304, as utilized in a processing system 301, may be used to implement any one or more of the processes described below and illustrated in FIG. 10.

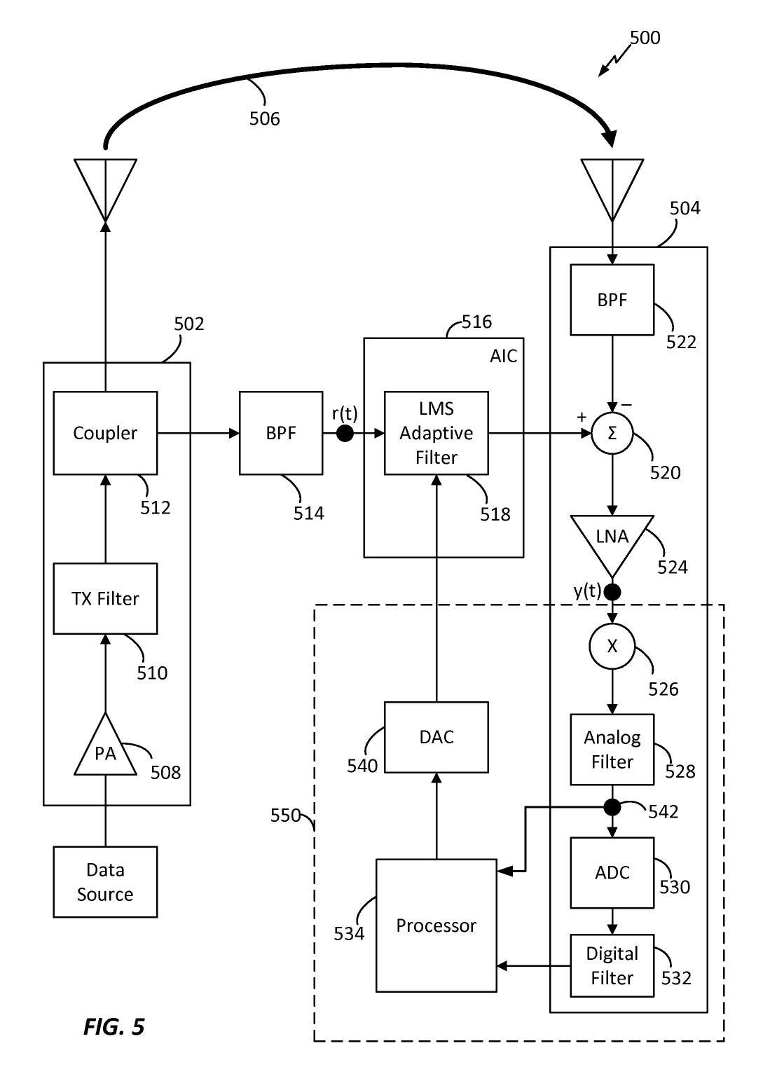

The processor 304 may include in-device interference determination circuitry 304-a configured to determine one or more characteristics of an interference signal affecting receive performance, including but not limited to a power level of an interfering signal output by an analog filter 528 (see FIG. 5). The processor 304 may further include coefficient generation and application circuitry 304-b configured to determine a digital coefficient for interference cancellation of an interfering signal based on a baseband signal, as well as applying the determined coefficient to an interference cancellation circuit to cancel the interfering signal. The processor 304 may further include DC offset generation circuitry 304-c configured to determine a DC offset to be applied to an interference cancellation circuit, e.g., in accordance with a baseband signal, with an aim to steer a cancellation region in accordance with characteristics of the interfering signal.

One or more processors 304 in the processing system 301 may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium 306. The computer-readable medium 306 may be a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. The computer-readable medium may also include, by way of example, a carrier wave, a transmission line, and any other suitable medium for transmitting software and/or instructions that may be accessed and read by a computer. The computer-readable medium 306 may reside in the processing system 301, external to the processing system 301, or distributed across multiple entities including the processing system 301. The computer-readable medium 306 may be embodied in a computer program product. By way of example, a computer program product may include a computer-readable medium in packaging materials. Those skilled in the art will recognize how best to implement the described functionality presented throughout this disclosure depending on the particular application and the overall design constraints imposed on the overall system.

The computer-readable medium 306 may include in-device interference determination software 306-a configured to determine one or more characteristics of an interference signal affecting receive performance, including but not limited to a power level of an interfering signal output by an analog filter 528 (see FIG. 5). The computer-readable medium 306 may further include coefficient generation and application software 306-b configured to determine a digital coefficient for interference cancellation of an interfering signal based on a baseband signal, as well as applying the determined coefficient to an interference cancellation circuit to cancel the interfering signal. The computer-readable medium 306 may further include DC offset generation software 306-c configured to determine a DC offset to be applied to an interference cancellation circuit, e.g., in accordance with a baseband signal, with an aim to steer a cancellation region in accordance with characteristics of the interfering signal.

In various aspects, the apparatus 300 includes an interference cancellation (IC) circuit 320 configured to cancel in-device interference produced by the transceivers 310 that are operating on the same, adjacent, or harmonic/sub-harmonic frequencies. The processor 304 may adjust the settings of the IC circuit 320 to adjust the amplitude, phase, and/or delay of an input signal to generate an output.

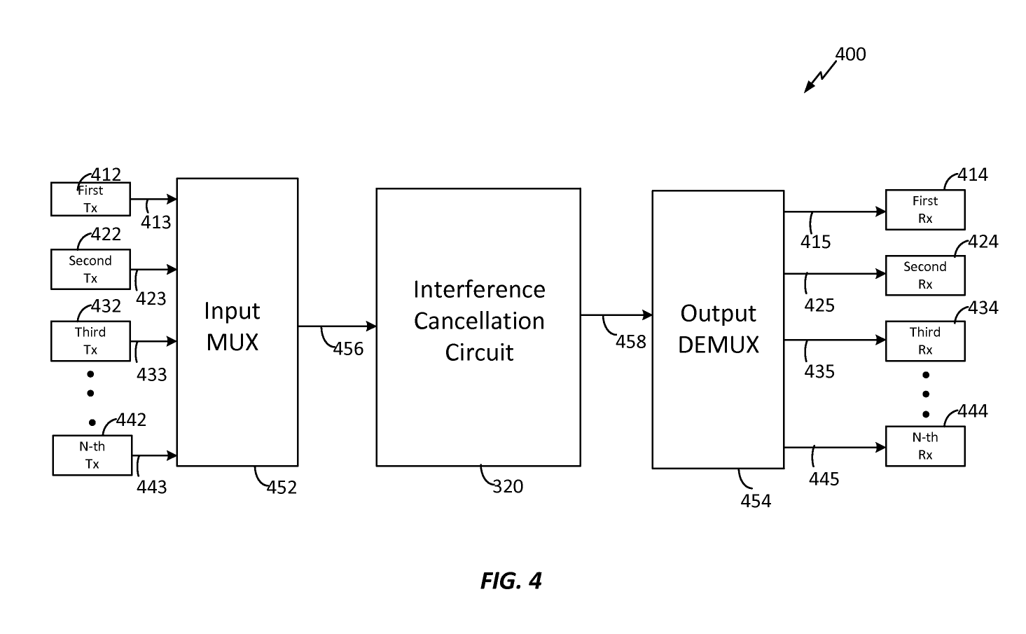

FIG. 4 is a block diagram illustrating a wireless communication device 400 (e.g., the apparatus 301 illustrated in FIG. 3) having plural transmitters and plural receivers, in accordance with some aspects of the present disclosure. At least a portion of the wireless communication device 400 may be implemented with the processing system 301 (e.g., see FIG. 3).

With reference to FIGS. 2-4, in various aspects, the plurality of Tx/Rx circuits 310 may include any suitable number of Tx/Rx circuits such as, for example (but not limited to) a first Tx/Rx circuit 312, a second Tx/Rx circuit 314, a third Tx/Rx circuit 316, to an n-th Tx/Rx circuit 318. The first Tx/Rx circuit 312 may include a first transmitter 412 and a first receiver 414. The second Tx/Rx circuit 314 may include a second transmitter 422 and a second receiver 424. The third Tx/Rx circuit 316 may include a third transmitter 432 and a third receiver 434. The n-th Tx/Rx circuit 318 may include an n-th transmitter 442 and an n-th receiver 444. Depending on which transmitters are active (e.g., transmitting) and which receivers are active (e.g., receiving), any number of co-existence issues may occur.

Each of the Tx/Rx circuits 310 may operate according to various parameters, such as a respective frequency, radio frequency circuits with group delays, coupling channel gains to other Tx/Rx circuits, and/or the like. For instance, the first Tx/Rx circuit 312 may operate at a first frequency f1 with a first delay d1, the second Tx/Rx circuit 314 may operate at a second frequency f2 with a second delay d2, the third Tx/Rx circuit 316 may operate at a third frequency f3 with a third delay d3, and the n-th Tx/Rx circuit 318 may operate at an n-th frequency fn with an n-th delay d2. The first Tx/Rx circuit 312 may have a coupling channel gain h12 to the second Tx/Rx circuit 314, a coupling channel gain h13 to the third Tx/Rx circuit 316, and a coupling channel gain h1n to the n-th Tx/Rx circuit 318, respectively. Other Tx/Rx circuits 310 may have different coupling channel gains to various Tx/Rx circuit 310.

In various aspects, the apparatus 301 is configured to reduce interference produced among Tx/Rx circuits of the plurality of Tx/Rx circuits 310, for example, operating on the same, adjacent, harmonic, or sub-harmonic frequencies. In particular aspects, the apparatus 301 is configured to be adaptable for different Tx/Rx circuit combinations. That is, the apparatus 301 is configured to cancel interference based on the co-existence issue caused by the current combination of Tx/Rx circuits 310. For instance, for a first co-existence issue (e.g., at time T1) caused by a first combination of Tx/Rx circuits 310, such as the first transmitter 412 (e.g., WiFi transmitter) and the second receiver 424 (e.g., Bluetooth receiver), the apparatus 301 (e.g., via the processor 304) may select from among the transmitters and the receivers, the first transmitter 412 for providing an input to the IC circuit 320 and the second receiver 424 for receiving an output of the IC circuit 320. Accordingly, interference caused by an aggressor Tx/Rx circuit (e.g., the first transmitter 412) upon a victim Tx/Rx circuit (e.g., the second receiver 424) can be reduced. In this case, if the coupling channel gain from the aggressor Tx/Rx circuit to the victim Tx/Rx circuit is −10 dB (e.g., due to separation of two antennas), then the IC circuit 320 may need to match this gain for successful IC. For a second co-existence issue (e.g., at time T2) caused by a second (different) combination of Tx/Rx circuits, such as the first transmitter 412 (e.g., WiFi transmitter) and the third receiver 434 (e.g., LTE band 7), the apparatus 301 (e.g., via the processor 304) may select from among the transmitters and the receivers, the first transmitter 412 for providing an input to the IC circuit 320 and the third receiver 434 for receiving an output of the IC circuit 320. Accordingly, interference caused by an aggressor Tx/Rx circuit (e.g., the first transmitter 412) upon a victim Tx/Rx circuit (e.g., the third receiver 434) can be reduced. According to various aspects, in such a case, if the coupling channel gain from the aggressor Tx/Rx circuit to the victim Tx/Rx circuit is −50 dB (e.g., due to separation two antennas and band pass filtering at the victim Tx/Rx circuit), then the IC circuit 320 may need to match this gain for successful interference cancellation.

In various aspects, the device 400 may be configured to select the Tx/Rx circuits (e.g., one or more transmitters and one or more receivers) associated with a co-existence issue. In particular aspects, the processor 304 or the like selects the Tx/Rx circuits causing a co-existence issue for processing by the IC circuit 320, for example, in response to detection of the co-existence issue between the at least two Tx/Rx circuits. For instance, in some aspects, the transmitters 412, 422, 432, 442 may be coupled to an input multiplexer (MUX) 452 to receive corresponding signals 413, 423, 433, 443 from the transmitters 412, 422, 432, 442. The input multiplexer 452 is coupled to the IC circuit 320 to allow the input multiplexer 452 to select (e.g., as controlled by the processor 304) one of the signals 413, 423, 433, 443 from one of the transmitters 412, 422, 432, 442 as input signal 456 to the IC circuit 320.

The receivers 414, 424, 434, 444 may be coupled to an output multiplexer/demultiplexer (DEMUX) 454 to receive corresponding signals 415, 425, 435, 445 from the output multiplexer 454. The output multiplexer 454 is coupled to the IC circuit 320 to allow the output multiplexer 454 to select (e.g., as controlled by the processor 304) one of the receivers 414, 424, 434, 444 to receive an output signal 458 from the IC circuit 320.

For example, for a co-existence issue caused by a combination of Tx/Rx circuits, such as the first transmitter 412 (e.g., WiFi transmitter) and the third receiver 434 (e.g., LTE band 7), the processor 304 may select from among the transmitters, the first transmitter 412 for providing the input signal 456 to the IC circuit 320, and the processor 304 may select from among the receivers, the third receiver 434 for receiving the output signal 458 from the IC circuit 320. Likewise, in response to detecting a different co-existence issue caused by a different combination of the Tx/Rx circuits 310, the processor 304 may select the Tx/Rx circuits causing the different co-existence issue. In some aspects, the processor 304 may activate the IC circuit 320, which may be deactivated or in a reduced power state, in response to detecting a co-existence issue.

Referring now to FIG. 5, a block diagram of a system 500 for cancelling in-device interference between a transmitter 502 and a receiver 504 in accordance with some aspects of the disclosure is shown. The system 500 may be associated with one or more systems, devices, or components, such as the systems, devices, and components described above in connection with FIGS. 2-4. For example, the transmitter 502 may be an offending transmitter selected from among the first, second, third, or n-th transmitters 412, 422, 432, or 442, and the receiver 504 may be a victim receiver selected from among the first, second, third, or n-th receivers 414, 424, 434, or 444.

That is, the transmitter 502 may be the offender, generating or causing in-device interference in connection with an over-the-air signal 506 received by the victim receiver 504. The offending transmitter 502 and victim receiver 504 may be part of the same device (e.g., the apparatus 301). Moreover, while a single transmitter 502 and a single receiver 504 are shown, more than one transmitter 502 and/or more than one receiver 504 may be provided in accordance with aspects of the disclosure.

Associated with, or coupled to, the transmitter 502 may be a power amplifier (PA) 508 and a TX filter 510. These components are well-known in the art and so a further description is omitted for the sake of brevity. The PA 508 may receive a signal or data for transmission by the TX 502.

The transmitter 502 may be associated with a coupler 512. The coupler 512 may be used to provide, potentially via a bandpass filter (BPF) 514, a reference signal r(t), which may correspond to some portion or function of the signal transmitted by the transmitter 502, to an AIC circuit 516. The AIC circuit 516 may in some examples include a one-tap least mean squares (LMS) adaptive filter 518. Broadly, the AIC circuit 516 may be configured to generate an output signal that matches the over-the-air interfering signal 506 as closely as possible, such that the AIC output can be combined with the interfering signal 506 in a destructive fashion to cancel the in-device interference signal.

The AIC 516 and/or the LMS adaptive filter 518 may be configured to generate an output that may be supplied as a first input to a combiner, integrator, or adder 520. A second input to the adder 520 may correspond to the signal 506 received by the RX 504, as potentially subject to a BPF 522.

The adder 520 may be configured to combine its first and second inputs in order to generate an output that is provided to a low-noise amplifier (LNA) 524. For example, the adder 520 may be configured to subtract its first input (e.g., the output from the AIC 516/filter 518) from its second input (e.g., the output of the BPF 522). Ideally, with a perfect selection of LMS filter coefficients, the signal provided at the first input of the adder 520 is equal to the interference associated with the over-the-air signal 506, such that the interference is removed in the signal provided to the LNA 524. In this respect, the path from the coupler 512, through the BPF 514, to the AIC 516/filter 518 may serve as a reference path in order to provide a reference signal r(t).

The system 500 may provide for the BPF 514 in the reference signal path and the BPF 522 coupled to the receiver antenna to have substantially the same filter characteristics. That is, filtering both signals in substantially the same way can help ensure that any timing mismatch between the reference signal r(t) and the received signal 506 is reduced or eliminated.

In an aspect of the disclosure, as described in further detail below, the AIC circuit 516 may utilize, as an input to its interference cancellation function, coefficients and/or offsets that are not directly based on the RF output signal y(t) that is output from the LNA 524, but rather, the coefficients and/or offsets are based on the received signal after it is converted into a baseband signal. That is, a coefficient controller 550, which may be represented by the components in FIG. 5 surrounded by the dashed-line box, may generate one or more coefficients to apply to the AIC 516 based on a baseband signal.

That is, the output y(t) from the LNA 524 may be provided to a mixer 526. The mixer 526 then coverts the output y(t) from the LNA 524 from a first signal domain or frequency (e.g., radio frequency or RF) to a second signal domain or frequency (e.g., baseband). Here, a baseband signal may include an unmodulated signal, a lowpass signal, or a signal at relatively low frequencies, in some examples corresponding to an audible range (e.g., up to 20 kHz). While not shown in FIG. 5, the mixer 526 may receive a signal from an oscillator (e.g., a voltage-controlled oscillator (VCO)) in order to provide the conversion to baseband.

The output baseband signal from the mixer 526 is provided to an analog filter 528. The filter 528 may serve as an anti-aliasing filter. The output of the filter 528 is provided to an analog-to-digital converter (ADC) 530. The output of the ADC 530 may optionally be provided to a digital filter 532. (In another example, not illustrated, the digital filter 532 may be omitted so that the processor 534 may compute the digital coefficient directly from digital samples of the baseband signal output from the ADC 530.) The output of the digital filter 532 is provided to a processor 534. In some examples, the processor 534 may correspond to the processor 304 of FIG. 3.

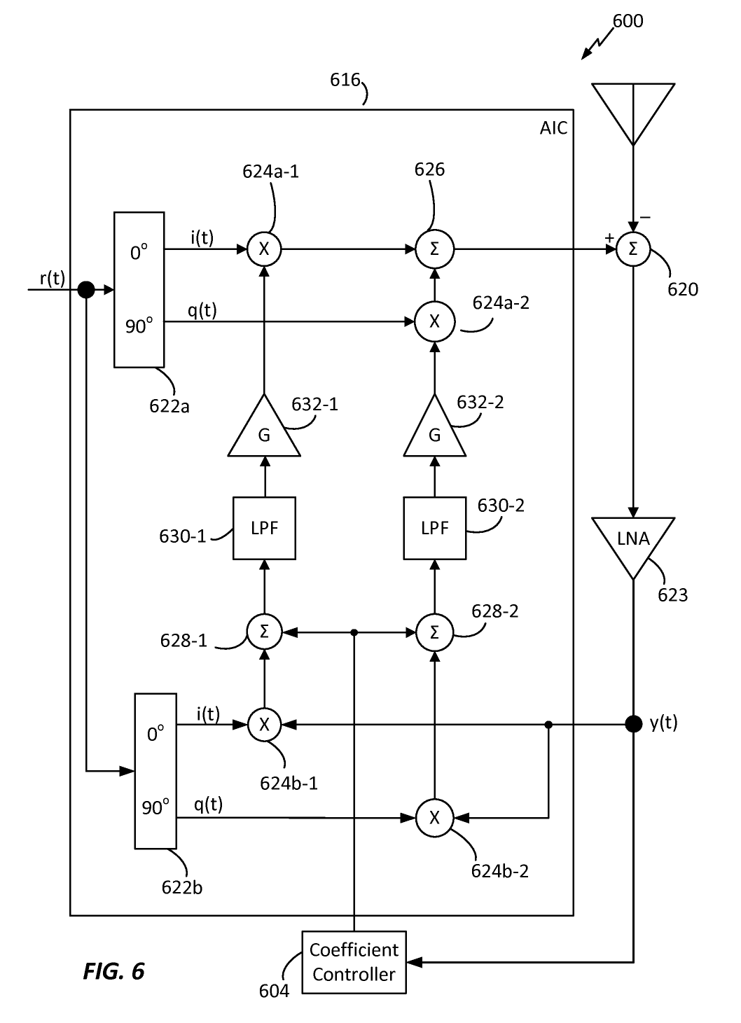

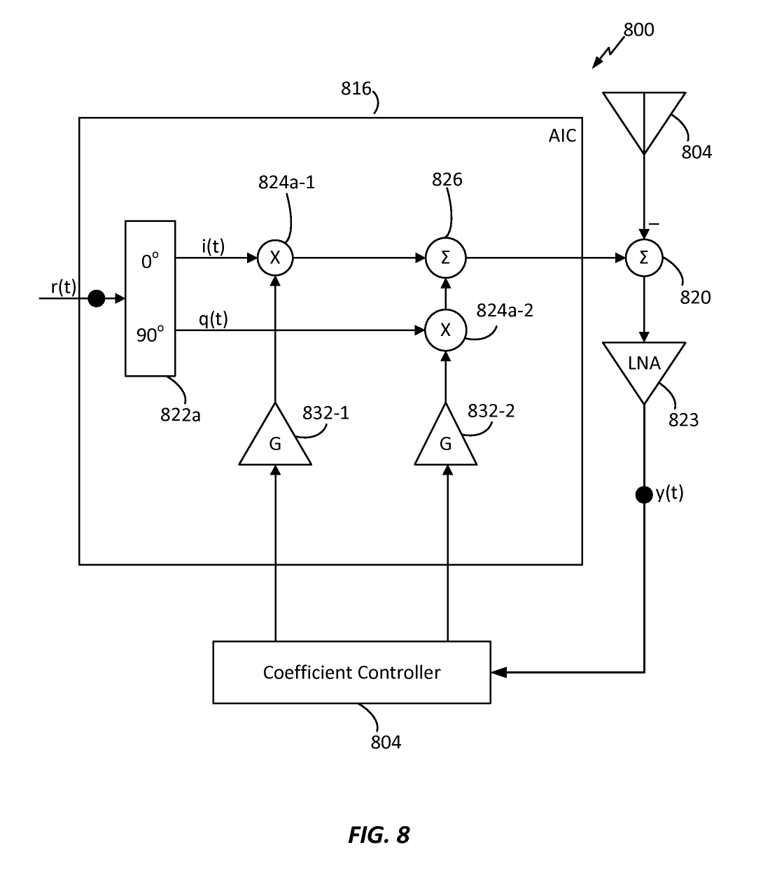

In accordance with some aspects of the disclosure, the processor 534 is configured to generate and output one or more of a (representation of a): (1) DC offset, or (2) coefficients (e.g., LMS coefficients) to the AIC circuit 516. For ease of description, when utilized in the present disclosure, the output of the coefficient controller 550 (similarly, coefficient controllers 604 and 804 in FIGS. 6 and 8, respectively) may be referred to simply as a coefficient. However, this is to be understood to include not only LMS coefficient(s), but additionally or alternatively, DC offset value(s).

In a further aspect of the disclosure, the output of the processor 534 may be in a digital format. Here, the digital output of the processor 534 may be provided to a digital-to-analog converter (DAC) 540. The output of the DAC 540 may then be provided to the AIC 516 and/or the LMS filter 518.

One or more of the components 528-540 (e.g., those in box 550), potentially in combination with at least a portion of the mixer 526, may serve as an automated coefficient controller. The coefficient controller may be operative on the basis of having observed the signal 506 after a conversion to baseband. In some examples, coefficient control can be conducted entirely at baseband (e.g., see FIG. 8). In other examples, coefficient control can be conducted partially at baseband in combination with analog LMS (e.g., see FIG. 6). One or more algorithms (e.g., baseband algorithms) used or executed by the controller can be “blind” or “conventional.” A blind algorithm might not make use of a reference r(t), whereas a conventional algorithm may incorporate the use of a reference r(t). The coefficient controller, by generating the DC offset and/or coefficients, may provide for an automatic steering of a cancellation region such that the cancellation center is focused on the frequency or frequencies where the power of the interference associated with the signal 506 is highest.

Referring now to FIG. 6, a block diagram of an in-device interference cancellation system 600 in accordance with some aspects of the disclosure is shown. The system 600 illustrates an example of in-device interference cancellation conducted partially at baseband in combination with analog LMS interference cancellation. The system 600 includes a receive antenna, an adder 620, and an LNA 623, which may be the same as similar as those components described above in connection with the system 500 of FIG. 5.

As illustrated, the system 600 provides for AIC utilizing a one-tap LMS filter 616. In an aspect of the present disclosure, a coefficient controller 604 may generate LMS coefficients and/or a DC offset that may be utilized to steer a cancellation region of the LMS filter 616 to improve interference cancellation performance.

In various examples, the coefficient controller 604 may include one or more components or devices. For example, the coefficient controller 604 may include one or more of the components 526-540 described above in connection with FIG. 5 (i.e., the block 550). That is, in an aspect of the disclosure, as described in further detail below, the coefficient controller may generate LMS coefficients and/or a DC offset for steering the interference cancellation region of the AIC circuit 616 based on observations of the output signal y(t) after conversion to the baseband (i.e., with reference to FIG. 5, the signal after the mixer 526). By utilizing the signal at baseband, the cancellation region can be better steered to the desired center frequency and can result in improved interference cancellation.

In accordance with some aspects of the disclosure, the AIC circuit (e.g., the LMS filter 616) may correspond to the AIC circuit 516 of FIG. 5. An input reference signal r(t) may be provided to the AIC circuit 616 from the interfering transmitter circuit, to be utilized as a reference for interference cancellation. The AIC circuit 616 may include polyphase components 622a and 622b. The polyphase components 622a and 622b are used to generate in-phase i(t) and quadrature q(t) signal outputs relative to the input signal r(t). The in-phase signal output i(t) may be generated by simply passing the input signal r(t) with no phase shift (e.g., a 0 degree phase shift). The quadrature signal output q(t) may be generated by applying a 90 degree phase shift to the input signal r(t).

The in-phase signal i(t) output by a first polyphase component 622a is provided to a mixer 624a-1. The quadrature signal q(t) output by the first polyphase component 622a is provided to a mixer 624a-2. The outputs of the mixers 624a-1 and 624a-2 are provided to an adder, integrator, or combiner 626. The output of the adder 626 serves as an input to the adder 620.

The in-phase signal i(t) output by a second polyphase component 622b is provided to a mixer 624b-1. The quadrature signal q(t) output by the second polyphase component 622b is provided to a mixer 624b-2. The mixers 624b-1 and 624b-2 each receive a second input corresponding to the output of the LNA 623 (denoted as y(t) in FIG. 6). That is, in some aspects of the disclosure, feedback corresponding to the output signal y(t) is provided as an input to the AIC circuit 616.

The output of the mixer 624b-1 is provided to a first adder or integrator 628-1. The output of the mixer 624b-2 is provided to a second adder or integrator 628-2. A second input to each of the integrators 628-1 and 628-2 corresponds to the output provided by the controller 604.

The outputs of the integrators 628-1 and 628-2 may be provided to one or more filters, such as first and second low pass filters (LPFs) 630-1 and 630-2. The outputs of the first and second LPFs 630-1 and 630-2 may be provided to one or more amplifiers 632-1 and 632-2, respectively. The amplifiers 632-1 and 632-2 may each have their own gain (G). In some instances, a common gain may be used in connection with both of the amplifiers 632-1 and 632-2. The outputs of the amplifiers 632-1 and 632-2 may be provided as inputs to the mixers 624a-1 and 624a-2, respectively.

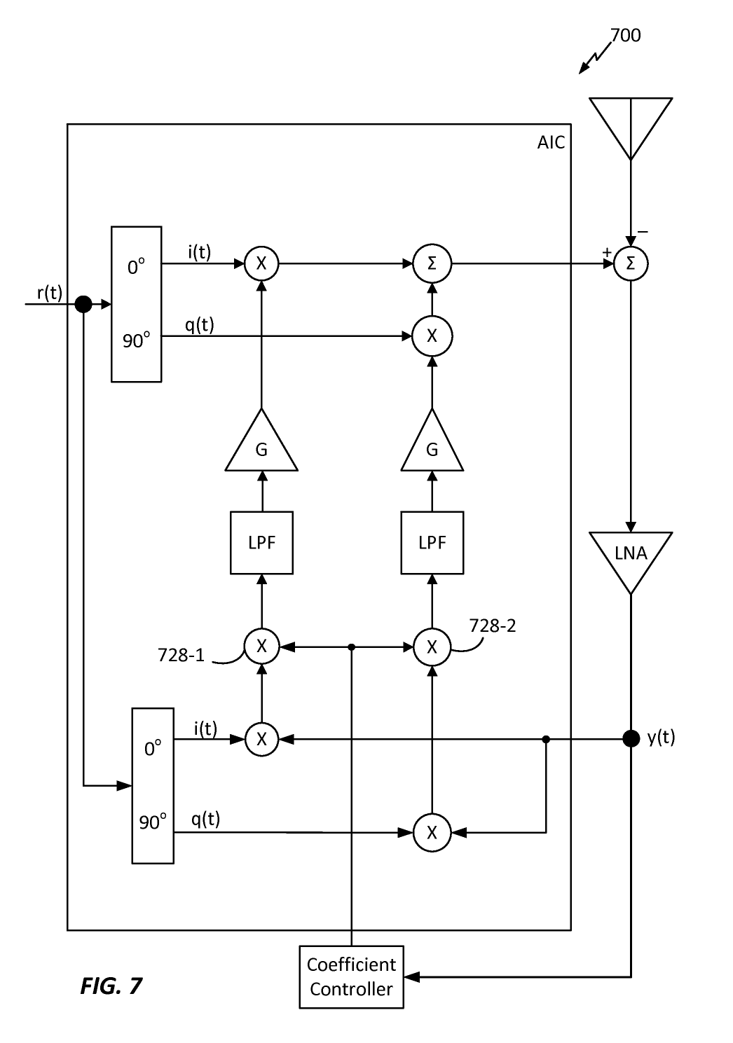

Thus, in the illustrated example, feedback information corresponding to the output signal y(t) may be suitably combined with the input interfering signal r(t) to reduce interference on the receiver caused by the interfering transmitter. The coefficient controller 604 may be configured to generate a suitable coefficient in the digital domain, which may be converted to an analog coefficient utilizing a DAC (e.g., DAC 540) and applied to the integrators 628-1 and 628-2 to provide for a DC offset that may steer the cancellation region of the AIC circuit 616. Although the illustrated example shows the coefficient being additively applied, utilizing adders or integrators 628-1 and 628-2, in another example (illustrated in FIG. 7), the coefficient may be multiplicatively applied to the LMS filter. For example, as illustrated in FIG. 7, the adders or integrators 628-1 and 628-2 may be replaced with multipliers 728-1 and 728-2, respectively. That is, a DC offset may be applied additively or multiplicatively according to implementation details. In any case, by virtue of the coefficient being generated based on the baseband signal, automatic steering of the cancellation region can take place, improving the performance of the LMS filter.

Referring now to FIG. 8, a block diagram of an exemplary system 800 in accordance with another aspect of the disclosure is shown. The system 800 illustrates an example of in-device interference cancellation conducted entirely at baseband. Some portions of the system 800 are similar to the system 600 describe above, and so, a complete re-description is omitted for the sake of brevity. In terms of differences between the systems 600 and 800, the AIC 816 does not include the polyphase component 622b, the mixers 624b-1 and 624b-2, the integrators 628-1 and 628-2, or the LPFs 630-1 and 630-2. Furthermore, the AIC 816 does not receive the output y(t) from the LNA 823 as a feedback signal. The simplification in terms of the component structure of the AIC 816 relative to the AIC 616 is based on the use of digital coefficients generated by the coefficient controller 804.

This example utilizes a simplified AIC circuit 816 relative to the one-tap LMS AIC circuit 616 described above in relation to FIG. 6. Because the coefficients are generated digitally, and because the RF output signal y(t) is not provided as feedback to the AIC circuit 816, this simplified AIC circuit 816 needs not to rely on certain analog components that generate the coefficient in the RF domain. Furthermore, by virtue of the elimination of the RF feedback into the AIC circuit 816, the system 800 may be less susceptible to generating noise that might otherwise result from the RF feedback from the LNA 823.

In some examples, the system 800 might suffer to a lesser extent from the DC offset issue of conventional LMS filter. Furthermore, relative to the system 600 illustrated in FIG. 6, it can be seen that the signal r(t) is not divided in two, to be sent to two polyphase components 622a and 622b. Such splitting of the reference signal r(t) generally results in a 3 dB loss, which can be avoided in the example in FIG. 8.

Much of the above description has dealt with what might be referred to as conventional LMS, wherein a reference signal r(t) is available to assist the interference cancellation. However, in some aspects of the disclosure, a reference signal r(t) from the interfering or offending transmitter may not be available, or may not be provided. For example, the interference suffered at the receiver may not be in-device interference, coming from the offending transmitter in the same communication device, such that a reference signal would not be available. In another aspect, a partially blind approach may be utilized, wherein an existing reference signal r(t) that is utilized in baseband interference cancellation, may be re-used for the generation of LMS coefficients.

In general, a blind search for LMS coefficients may be performed utilizing a suitable coefficient determination algorithm. LMS coefficients may be selected with an aim to reduce or minimize a residual power of the received signal after applying interference cancellation. In some examples, LMS coefficient selection may follow an iterative approach, where coefficients may be selected, and tested, and re-selected and re-tested until certain stopping criteria are satisfied, such as a level of residual power corresponding to the interference is below a given threshold.

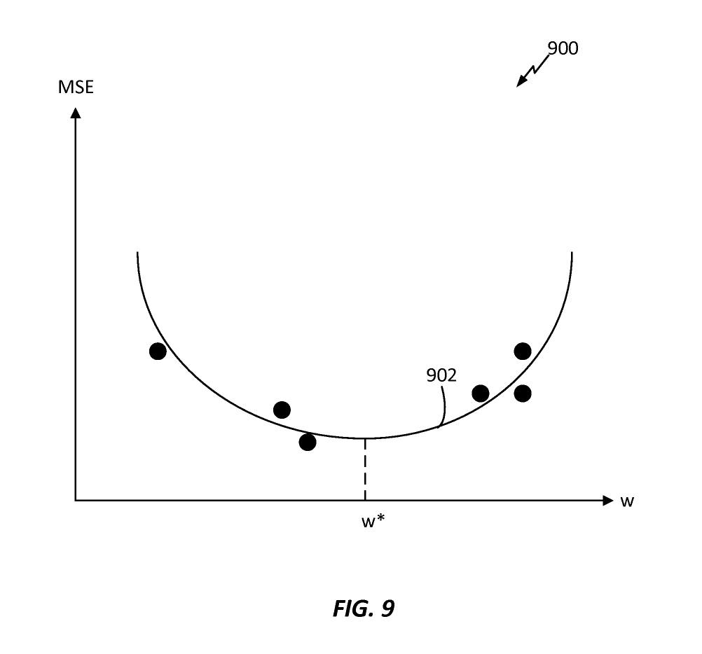

One approach or technique that may be used in connection with a blind search algorithm is curve fitting. An example of a curve fitting approach is described below in connection with FIG. 9. In FIG. 9, a chart 900 is shown. The vertical axis of the chart 900 may correspond to a mean squared error (MSE) of the power in a receiver band after analog filtering (e.g., utilizing analog filter 528) is performed. The horizontal axis (w) of the plot 900 may correspond to LMS coefficient values.

In an aspect of the disclosure, any suitable number of data points may be generated by testing a range of coefficients and measuring the output 542 of the analog filter 528 correspond to samples having been taken. In FIG. 9, six data points are shown corresponding to six samples. Of course, more or less than six samples may be provided.

Once the samples are acquired, a curve 902 may be fit to the samples. Any suitable curve fitting technique may be utilized within the scope of the disclosure, including but not limited to a least squares (LS) technique or minimum mean square error (MMSE) technique, to estimate the form or shape of the curve 902. In general, the accuracy of the curve 902 relative to the samples may be enhanced as the number of samples taken increases. Once the curve 902 is established, an optimum observation (w*) may be determined, corresponding to the point where the MSE or power value is a minimum. Accordingly, the LMS coefficient may be selected according to the value w*, i.e., the minimum of the fitted curve in FIG. 9.

In another aspect of the disclosure, another approach or technique that may be used in connection with a blind search algorithm for selecting a filter coefficient is a statistical or stochastic approximation. Stochastic approximation methods are known to those of ordinary skill in the art, and generally involve iterative processes or algorithms to find zeroes or minimums of functions. An example of a stochastic approximation that may be used is the so-called Kiefer-Wolfowitz procedure. The basic iteration using the Kiefer-Wolfowitz procedure may be expressed as:

θₙ₊₁=θₙ+αₙ[−∇f(θ)+ωₙ]

where θₙ represents the n-th estimate of a coefficient θ, αₙ represents a damping factor, ∇ represents the gradient operator, and ωₙ represents noise observations.

In the above expression, one or more stationary points or optimum points over the noise observations ωₙ may be obtained when the process converges (e.g., when θₙ₊₁ is (approximately) equal to θₙ). This condition may be satisfied when ∇f is (approximately) equal to ωₙ. However, it can be difficult or even impossible to compute ∇f. In such instances, ∇f may be approximated using partial derivatives as reflected by the expression:

$$\frac{\partial f}{\partial {θ}_{i / q}} \approx \frac{f ( θ + {δ}_{i / q} ) - f ( θ - {δ}_{i / q} )}{2 {δ}_{i / q}}$$

where δ_{i/q} is representative of a perturbation and the i/q notation is representative of the existence or presence of: (1) a real or in-phase (i) value, and (2) an imaginary or quadrature (q) value.

In another aspect of the disclosure, the processor or coefficient controller may determine the digital coefficients for the LMS filter utilizing gradient information. For example, a point of steepest descent in the i/q plane may be selected. In other aspects of the disclosure, a quadratic optimization algorithm or a genetic algorithm, the details of which are known to those of ordinary skill in the art, may be utilized to determine the digital coefficients for the LMS filter.

Accordingly, a blind estimation or approximation of LMS filter coefficients may be utilized according to some aspects of the disclosure. That is, the coefficient controller 550, 604, or 804 may utilize one or more of the curve fitting technique, the stochastic technique, gradient information, quadratic optimization, a genetic algorithm, or another suitable algorithm to select LMS filter coefficients for the AIC filter to reduce or minimize in-device interference.

Referring now to FIG. 10, a flow chart of a method 1000 for interference cancellation in accordance with some aspects of the disclosure is shown. The method 1000 may be tied to, or executed by, one or more systems, devices, or components. For example, the method 1000 may be executed by one or more of the systems, devices, or components described herein, as detailed above in connection with FIGS. 2, 3, 4, 5, 6, 7, and/or 8. The method 1000 may provide interference cancellation (e.g., in-device interference cancellation) in a wireless communication device having at least one transmitter and at least one receiver. For example, the method 1000 may be used to provide analog interference cancellation using a one-tap LMS circuit, or any of the analog interference cancellation circuits described above and illustrated, e.g., in FIGS. 6, 7, and/or 8.

In block 1002, a signal may be received. For example, the signal may be received by a receiver (e.g., receiver 504). The signal may include interference (e.g., in-device interference) that may be caused by an aggressor (e.g., transmitter 502).

In block 1010, the received signal of block 1002 may be observed at baseband, e.g., after downconversion by a mixer 526. In some examples, a digital filter (e.g., digital filter 532) may be applied prior to the observation of block 1010.

In block 1018, one or more digital coefficients may be determined, potentially based on the use of coefficient generation and application circuitry 304-b, DC offset generation circuitry 304-c, coefficient generation and application software 306-b, and/or DC offset generation software 306-c. The digital coefficients may be determined, for example, by the processor 304, the processor 534, the controller 604, and/or the controller 804 of FIGS. 3, 5, 6, and/or 8 described above. As indicated above, in this case, “coefficients” can refer to a DC offset, LMS filter coefficients, or a combination of the above. In various examples, the digital coefficients may be determined with or without the use of a reference signal r(t). When a reference signal is used, the reference may be applied in connection with digital or analog cancellation. When a reference is not used, one or more blind algorithms (e.g., stochastic approximation, gradient information, a genetic algorithm for quadratic optimization, etc.) may be used to provide blind digital coefficient control.

The digital coefficients may be determined based on the observation of the baseband signal performed in block 1010. For example, at block 1018 the digital coefficients may be determined by determining a power of the baseband signal corresponding to each of a plurality of sample digital coefficients, and selecting a coefficient from among the sample coefficients in accordance with the determined power. That is, a plurality of iterations may be performed in accordance with respective sample coefficients, and the power of the baseband signal may be determined in accordance with each sample coefficient. In some examples, the digital coefficients may be selected from among the sample coefficients in order to minimize the power of the observed baseband signal (e.g., the signal 542 output from an analog filter 528 functioning at baseband), e.g., in accordance with an estimated curve corresponding to the sample digital coefficients. In some aspects of the disclosure, the power of the baseband signal may be determined in accordance with a filtered version of the baseband signal. Here, any suitable filter may be applied to the baseband signal, including but not limited to an average over a time window; a finite impulse response or infinite impulse response filter; a rolling average; or any other suitable filter. Furthermore, in some aspects of the disclosure, the power of a subset of the baseband signal may be observed. For example, the filtered version of the baseband signal may be based on part of the baseband signal in the frequency domain, or a part of the baseband signal in the time domain. The digital coefficients may be selected to steer a cancellation region to a desired point, e.g., in accordance with a power of the interfering signal (such as a frequency where the power of the interference is at its highest).

In block 1026, the digital coefficients of block 1018 may be converted to analog coefficients, e.g., utilizing a digital-to-analog converter (DAC) 540.

In block 1034, the processor may apply the analog coefficients to at least one analog interference cancellation circuit (e.g., AIC 516, 616, or 816) or a component thereof. As described above, in the case that the coefficient corresponds to a DC offset, the application of the offset may be additive or multiplicative to a 1-tap analog LMS circuit.

In block 1040, the processor may determine whether one or more stopping criteria are satisfied. In some examples, the stopping criteria may correspond to a reduction or cancellation of interference in the received or observed signal at a particular frequency or frequency band, such that the interference that remains following the reduction or cancellation is less than a threshold. For example, in-device interference determination circuitry 304-a and/or software 306-a may be utilized to determine the interference power and compare the observed interference with a threshold. The threshold 305c may be stored in the memory 305, and may be expressed in terms of an accuracy of decoding, potentially via the use of an error rate (e.g., block error rate) or a signal-to-noise ratio (SNR). If the stopping criteria is not satisfied, flow may proceed to block 1002. Otherwise, if the stopping criteria is satisfied the method 1000 may end.

In accordance with aspects of the disclosure, the method 1000 may correspond to an algorithm used to perform interference cancellation. The structure/components described above represent means that may be used for performing such interference cancellation.

Referring back to FIGS. 3-8, in one configuration, the apparatus 300 includes means for observing a signal at baseband, means for determining a digital coefficient for interference cancellation based on a baseband signal, means for converting the digital coefficient to an analog coefficient, means for applying the analog coefficient to an interference cancellation circuit, and means for repeating said observing, determining, converting, and applying until one or more stopping criteria are satisfied. In one aspect, the aforementioned means may be one or more processors 304 and/or circuits 304-a, 304-b, and/or 304-c configured to perform the functions recited by the aforementioned means. In another aspect, the aforementioned means may be respective portions of the block diagrams in FIGS. 4-8 as described above, or any suitable circuit or any apparatus configured to perform the functions recited by the aforementioned means.

Of course, in the above examples, the circuitry included in the processors is merely provided as an example, and other means for carrying out the described functions may be included within various aspects of the present disclosure, including but not limited to the instructions stored in the computer-readable medium 306, or any other suitable apparatus or means described in any one of the figures, and utilizing, for example, the processes and/or algorithms described herein in relation to FIG. 10.

Several aspects of a telecommunications system have been presented. As those skilled in the art will readily appreciate, various aspects described throughout this disclosure may be extended to various types of telecommunication systems, network architectures and communication standards.

Within the present disclosure, the word “exemplary” is used to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage or mode of operation. The term “coupled” is used herein to refer to the direct or indirect coupling between two objects. For example, if object A physically touches object B, and object B touches object C, then objects A and C may still be considered coupled to one another—even if they do not directly physically touch each other. For instance, a first die may be coupled to a second die in a package even though the first die is never directly physically in contact with the second die. The terms “circuit” and “circuitry” are used broadly, and intended to include both hardware implementations of electrical devices and conductors that, when connected and configured, enable the performance of the functions described in the present disclosure, without limitation as to the type of electronic circuits, as well as software implementations of information and instructions that, when executed by a processor, enable the performance of the functions described in the present disclosure.

One or more of the components, steps, features and/or functions illustrated in the figures may be rearranged and/or combined into a single component, step, feature or function or embodied in several components, steps, or functions. Additional elements, components, steps, and/or functions may also be added without departing from novel features disclosed herein. The apparatus, devices, and/or components illustrated in the FIGS. may be configured to perform one or more of the methods, features, or steps described herein. The novel algorithms described herein may also be efficiently implemented in software and/or embedded in hardware.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A method of performing interference cancellation in a device having at least one transmitter and at least one receiver, the method comprising:
receiving an interfering signal from the transmitter at the receiver;
determining a digital coefficient for interference cancellation of the interfering signal, based on a baseband signal;
converting the digital coefficient to an analog coefficient; and
applying the analog coefficient to an interference cancellation circuit to cancel the interfering signal.

2. The method of claim 1, further comprising repeating the determining, converting, and applying until one or more stopping criteria are satisfied.

3. The method of claim 2, wherein the one or more stopping criteria comprises at least one of a reduction or cancellation of interference in the observed signal at a particular frequency or frequency band such that the interference that remains following the reduction or cancellation is less than a threshold.

4. The method of claim 1, wherein determining the digital coefficient comprises:
determining a power of the baseband signal corresponding to a plurality of sample digital coefficients; and
selecting the digital coefficient to correspond to a minimum power of the power of the baseband signal corresponding to an estimated curve corresponding to the sample digital coefficients.

5. The method of claim 4, wherein determining the power of the baseband signal comprises:
observing a filtered version of the baseband signal; and
determining the power of the filtered version of the baseband signal.

6. The method of claim 5, wherein observing a filtered version of the baseband signal comprises observing a subset of the baseband signal either in the frequency domain or in the time domain.

7. The method of claim 1, wherein determining the digital coefficient comprises at least one of: a stochastic approximation, use of gradient information, or use of a genetic algorithm for quadratic optimization.

8. The method of claim 1, wherein determining the digital coefficient comprises selecting the digital coefficient to steer an interference cancellation in accordance with a power of the interfering signal.

9. The method of claim 1, wherein the interference cancellation circuit comprises a one-tap least mean squares (LMS) circuit.

10. The method of claim 9, wherein the analog coefficients are additive to a 1-tap coefficient of the LMS circuit to adjust a DC offset.

11. The method of claim 9, wherein the analog coefficients are multiplicative to a 1-tap coefficient of the LMS circuit to adjust a DC offset.

12. An apparatus configured for wireless communication, comprising:
at least one processor;
a memory coupled to the at least one processor;
at least one transmitter coupled to the at least one processor;
at least one receiver coupled to the at least one processor; and
an interference cancellation circuit coupled between the at least one transmitter and the at least one receiver,
wherein the at least one processor is configured to:
receive an interfering signal from the transmitter at the receiver;
determine a digital coefficient for interference cancellation of the interfering signal, based on a baseband signal;
convert the digital coefficient to an analog coefficient; and
apply the analog coefficient to the interference cancellation circuit to cancel the interfering signal.

13. The apparatus of claim 12, wherein the at least one processor is further configured to repeat the determining, converting, and applying until one or more stopping criteria are satisfied, wherein the one or more stopping criteria comprises at least one of a reduction or cancellation of interference in the observed signal at a particular frequency or frequency band such that the interference that remains following the reduction or cancellation is less than a threshold.

14. The apparatus of claim 12, wherein the at least one processor, being configured to determine the digital coefficient, is further configured to:
determine a power of the baseband signal corresponding to a plurality of sample digital coefficients; and
select the digital coefficient to correspond to a minimum power of the power of the baseband signal corresponding to an estimated curve corresponding to the sample digital coefficients.

15. The apparatus of claim 12, wherein at least one processor, being configured to determine the digital coefficient, is further configured to select the digital coefficient to steer an interference cancellation in accordance with a power of the interfering signal.

16. The apparatus of claim 12, wherein the interference cancellation circuit comprises a one-tap least mean squares (LMS) circuit.

17. The apparatus of claim 16, wherein the analog coefficients are additive to a 1-tap coefficient of the LMS circuit to adjust a DC offset.

18. The apparatus of claim 16, wherein the analog coefficients are multiplicative to a 1-tap coefficient of the LMS circuit to adjust a DC offset.

19. An apparatus configured for wireless communication, comprising:
at least one transmitter;
at least one receiver;
means for interference cancellation, coupled between the at least one transmitter and the at least one receiver, and configured to apply interference cancellation to an interfering signal from the transmitter received at the receiver;
means for determining a digital coefficient for interference cancellation of the interfering signal, based on a baseband signal;
means for converting the digital coefficient to an analog coefficient; and
means for applying the analog coefficient to the means for interference cancellation to cancel the interfering signal.

20. The apparatus of claim 19, further comprising means for repeating the determining, converting, and applying until one or more stopping criteria are satisfied, wherein the one or more stopping criteria comprises at least one of a reduction or cancellation of interference in the observed signal at a particular frequency or frequency band such that the interference that remains following the reduction or cancellation is less than a threshold.

21. The apparatus of claim 19, wherein the means for determining the digital coefficient further comprises:
means for determining a power of the baseband signal corresponding to a plurality of sample digital coefficients; and
means for selecting the digital coefficient to correspond to a minimum power of the power of the baseband signal corresponding to an estimated curve corresponding to the sample digital coefficients.

22. The apparatus of claim 19, wherein the means for determining the digital coefficient, further comprises means for selecting the digital coefficient to steer an interference cancellation in accordance with a power of the interfering signal.

23. The apparatus of claim 19, wherein the means for interference cancellation comprises a one-tap least mean squares (LMS) circuit.

24. The apparatus of claim 23, wherein the analog coefficients are additive to a 1-tap coefficient of the LMS circuit to adjust a DC offset.

25. The apparatus of claim 23, wherein the analog coefficients are multiplicative to a 1-tap coefficient of the LMS circuit to adjust a DC offset.

26. A computer-readable medium storing computer executable code, operable on a device comprising at least one transmitter, at least one receiver, and an interference cancellation circuit coupled between the at least one transmitter and the at least one receiver, and configured to apply interference cancellation to an interfering signal from the transmitter received at the receiver, the computer executable code comprising:
instructions for causing a computer to determine a digital coefficient for interference cancellation of the interfering signal, based on a baseband signal;
instructions for causing a computer to convert the digital coefficient to an analog coefficient; and
instructions for causing a computer to apply the analog coefficient to the means for interference cancellation to cancel the interfering signal.

27. The computer-readable medium of claim 26, wherein the computer executable code further comprises:
instructions for causing a computer to repeat the determining, converting, and applying until one or more stopping criteria are satisfied, wherein the one or more stopping criteria comprises at least one of a reduction or cancellation of interference in the observed signal at a particular frequency or frequency band such that the interference that remains following the reduction or cancellation is less than a threshold.

28. The computer-readable medium of claim 26, wherein the instructions for causing a computer to determine the digital coefficient further comprise:
instructions for causing a computer to determine a power of the baseband signal corresponding to a plurality of sample digital coefficients; and
instructions for causing a computer to select the digital coefficient to correspond to a minimum power of the power of the baseband signal corresponding to an estimated curve corresponding to the sample digital coefficients.

29. The computer-readable medium of claim 26, wherein the instructions for causing a computer to determine the digital coefficient, further comprise instructions for causing a computer to select the digital coefficient to steer an interference cancellation in accordance with a power of the interfering signal.

30. The computer-readable medium of claim 26, wherein the interference cancellation circuit comprises a one-tap least mean squares (LMS) circuit, and wherein the analog coefficients are additive to a 1-tap coefficient of the LMS circuit to adjust a DC offset, or multiplicative to the 1-tap coefficient of the LMS circuit to adjust the DC offset.
